(19) United States
(12) Patent Application Publication
(10) Pub. No.: US 2009/0314405 A1
(43) Pub. Date: Dec. 24, 2009

(54) Tire traction device

(76) Inventors: Dominic Heroux, St-Lin des Laurentides (CA); Jacques Bourgouin, St-Lin des Laurentides (CA)

Correspondence Address: INVENTION QUEBEC INC., Suite 202, 8065 Boul. Viau, Montreal, QC, H1R 2T2, CA

(21) Appl. No.: 12/457,721

(22) Filed: Jun. 19, 2009

(30) Foreign Application Priority Data
Jun. 20, 2008 (GB) 0811325.0

(51) Int. Cl. B60C 27/00

(52) U.S. Cl. 152/225 C

(57) ABSTRACT

A traction device attachable to a tire mounted on a tire rim, the tire defining a pair of substantially annular and substantially opposed tire side walls, the tire also defining a tire thread extending between the tire side side walls, the traction device comprising: a first jaw, the first jaw defining a first jaw free end, the first jaw including a first tire gripping element provided substantially adjacent to the first jaw free end; a second jaw, the second jaw defining a second jaw free end, the second jaw including a second tire gripping element provided substantially adjacent to the second jaw free end; the first and second jaws being operatively coupled to each other so as to be movable between an open configuration and a closed configuration, the first and second tire gripping elements being closer to each other when the first and second jaws are in the closed configuration than when the first and second jaws are in the open configuration; the traction device further comprising a traction element extending between the first and second jaws substantially opposed to the first and second jaw free ends; wherein, when the traction device is operatively mounted to the tire with the first and second jaws in the closed configuration, the traction element extends across the tire thread and the first and second tire gripping elements grip a respective one of the tire side walls so as to pinch the tire between the first and second tire gripping elements.

This application claims priority from GB, No. 0811325.0.

### FIELD OF THE INVENTION

The present invention relates generally to tire traction devices for wheeled vehicles and, more particularly, to an improved tire traction device of the clip-on type that can be conveniently clamped about a peripheral portion of a rubber traction wheel of a vehicle.

### BACKGROUND

Tire traction devices of the clip-on type are known in the art and are useful in improving the traction qualities of the traction wheels of vehicles, particularly when a vehicle is stuck in snow or muddy ground. The tire traction devices of the prior art generally comprise a plurality of traction enhancing members that are secured about a traction wheel of a vehicle using various means such as chains, hooks, harness, belt buckles, tie bars and the like.

While these prior art devices generally offer a tire traction device that improves the traction qualities of traction wheels of a vehicle, they also entail one or more of the following disadvantages:

a) they generally comprise a plurality of traction enhancing members and attachment means, which generally involve a relatively long and complex installation and removal process, a particularly daunting task to accomplish in freezing weather conditions;

b) they generally require the installation of at least a pair of traction enhancing members on diametrically opposed peripheral portions of a wheel, which can be difficult to accomplish when the wheel is more than half buried in snow or mud and there is no shovel available;

c) they generally comprise relatively low profile traction enhancing elements secured about the periphery of the traction wheel, which is not particularly efficient when the wheel is stuck deep in snow or mud;

d) they generally comprise fastening means that come in contact with portions of the wheel covers or wheels of the vehicle and, thus, may damage their delicate aesthetical surfaces;

e) they are generally cumbersome and not easily stowable in the stowage compartment of a vehicle, more particularly so in typically small stowage compartment of compact and sub-compact vehicles;

f) they generally require adjustments to adapt the traction device to different diametrical sizes of rubber tires, and are generally fixedly adapted for standard width size tires; and

g) they generally comprise multiple components that require multiple-step processes to assemble and, thus, are relatively complex and expensive to manufacture.

Against this background, there exist a need for a new and improved tire traction device that avoids the aforementioned disadvantages. It is a general object of the present invention to provide a new and improved tire traction device.

### SUMMARY OF THE INVENTION

In a broad aspect, the invention provides a traction device attachable to a tire, the tire defining a pair of substantially annular and substantially opposed tire side walls, the tire also defining a tire thread extending between the tire side side walls, the traction device comprising: a first jaw, the first jaw defining a first jaw free end, the first jaw including a first tire gripping element provided substantially adjacent to the first jaw free end; a second jaw, the second jaw defining a second jaw free end, the second jaw including a second tire gripping element provided substantially adjacent to the second jaw free end; the first and second jaws being operatively coupled to each other so as to be movable between an open configuration and a closed configuration, the first and second tire gripping elements being closer to each other when the first and second jaws are in the closed configuration than when the first and second jaws are in the open configuration; the traction device further comprising a traction element extending between the first and second jaws substantially opposed to the first and second jaw free ends; wherein, when the traction device is operatively mounted to the tire with the first and second jaws in the closed configuration, the traction element extends across the tire thread and the first and second tire gripping elements grip a respective one of the tire side walls so as to pinch the tire between the first and second tire gripping elements.

Some advantages of the present invention are to provide a traction device:

a) which can be relatively quickly and relatively easily installed on and removed from the traction wheel of a vehicle;

b) which may be advantageously clamped about an upper peripheral portion of a traction wheel of a vehicle, a convenient aspect that is particularly useful when the traction wheel is almost completely buried in snow or mud;

c) which considerably improves the traction of a wheel of a vehicle that is stuck in deep snow or mud;

d) whose various components do not come in contact with the delicate aesthetical surfaces of the wheel covers or wheels of the vehicle;

e) which can be conveniently folded into a compact, stowable configuration, an appreciable aspect when considering the relatively limited stowage space available in some cars;

(f) which is compatible with a wide variety of tire sizes since it is not dependent of a rubber tire's diametrical size; and

g) which is relatively simple and relatively economical to produce.

In some embodiments of the invention, the traction element is a variable length traction element configurable between a shortest configuration and a longest configuration. In these embodiments, the proposed traction device can be readily adapted to rubber tires having different widths.

In some embodiments of the invention, the traction device includes an actuator operatively coupled to the first and second jaws for moving the first and second jaws between the open and closed configurations. In a variant, the actuator includes a lever that allows for the exertion of relatively large pinching forces onto the tire by an intended user with minimal muscular force exerted on the lever due to a suitable lever attachment point providing relatively large leverage.

The traction device may be advantageously made from conventional flat bar stock that has been preferably subjected to a rust-proof treatment, or may be made from any suitable rust-proof metals such as, for example, aluminum or stainless steel.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1, in a perspective view, illustrates a traction device in accordance with an embodiment of the present invention;

FIG. 2, in a fragmented exploded view, illustrates a traction element of the traction device of FIG. 1;

FIG. 3, in a side elevational view, illustrates a first step in the attachment of the traction device of FIGS. 1 to 2 to a rubber tire;

FIG. 4, in a side elevational view, illustrates a second step in the attachment of the traction device of FIGS. 1 to 3 to the rubber tire;

FIG. 5, in a side elevational view, illustrates a third step in the attachment of the traction device of FIGS. 1 to 4 to the rubber tire;

FIG. 6, in a side elevational view, illustrates the traction device of FIGS. 1 to 5, showing the device in a folded, compact and stowable configuration;

FIG. 7, in a perspective view, illustrates a traction device in accordance with an alternative embodiment of the present invention; and

FIG. 8, in front cross-sectional view taken along the line VIII-VIII of FIG. 7, illustrates a traction element of the traction device of FIG. 7.

### DETAILED DESCRIPTION

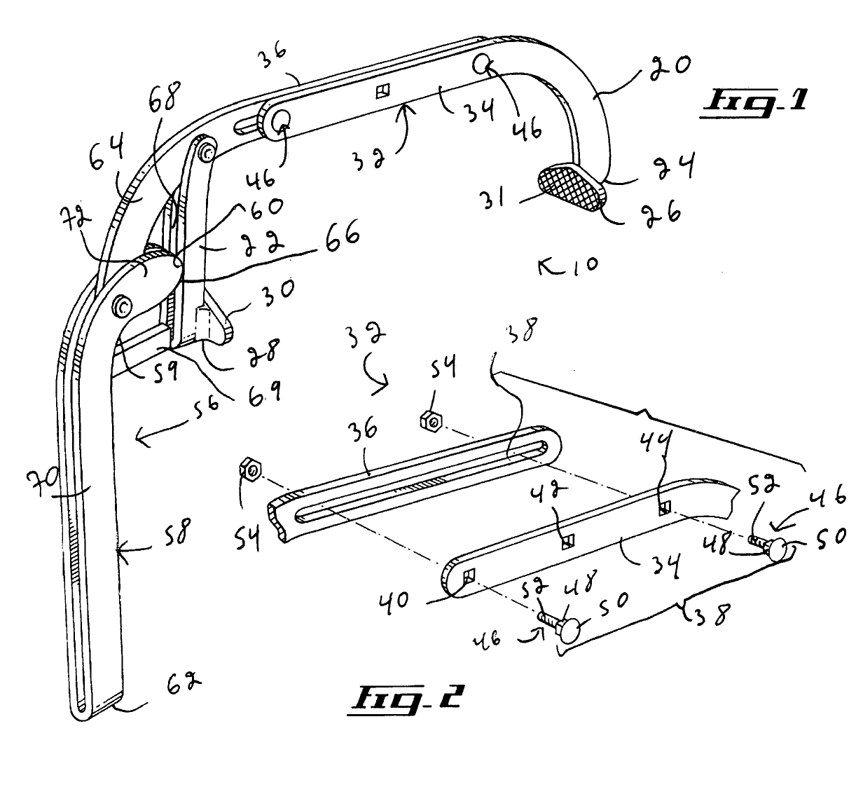

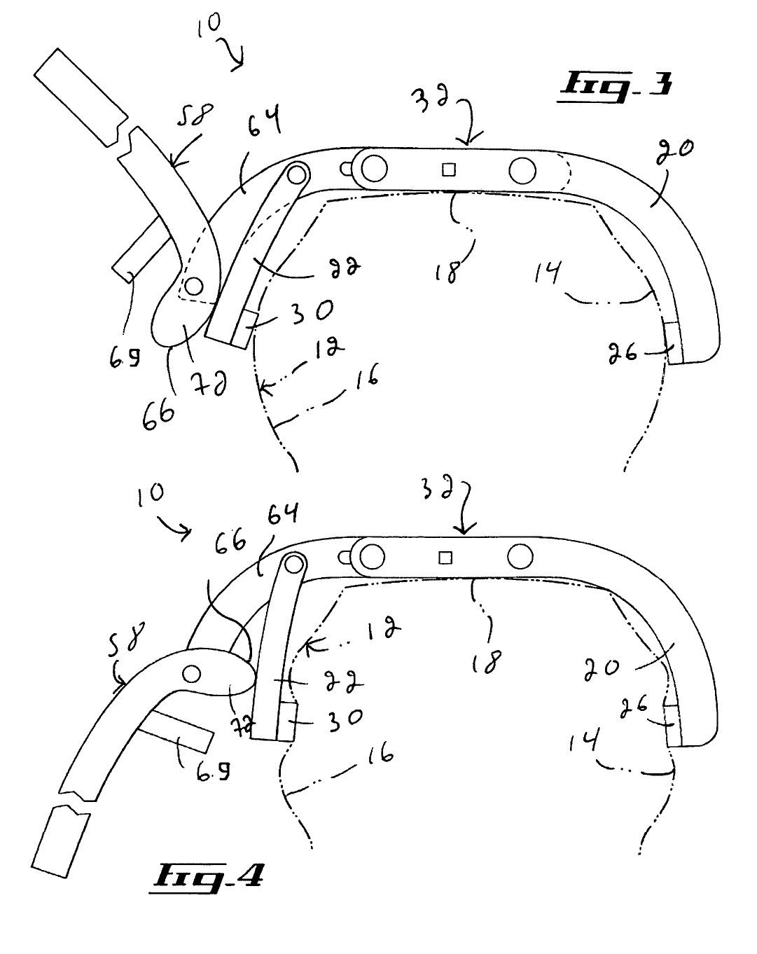

According to an embodiment of the present invention, FIG. 1 shows a traction device 10 attachable to a tire 12 (shown in FIGS. 3 to 5). Typically, the tire 12 is mounted on a wheel of a vehicle (not shown in the drawings). With reference to FIGS. 3 to 5, the tire 12 defines a pair of substantially annular and substantially opposed tire side walls 14 and 16 (only partially shown in FIGS. 3 to 5). The tire also defining a tire thread 18 extending between the tire side side walls 14 and 16.

The traction device 10 includes a first jaw 20, a second jaw 22, a traction element 32 and an actuator 56 (described in further details hereinbelow). The first jaw 20 defines a first jaw free end 24. The first jaw 20 includes a first tire gripping element 26 provided substantially adjacent to the first jaw free end 24. The second jaw 22 defines a second jaw free end 28, the second jaw 22 including a second tire gripping element 30 provided substantially adjacent to the second jaw free end 28. The traction element 32 extends between the first and second jaws 20 and 22 substantially opposed to the first and second jaw free ends 24 and 28. Typically, the second jaw 22 is pivotally coupled to the traction element 32, for example using a rivet, or a bolt and nut combination, among other possibilities, and the first jaw 20 extends integrally and fixedly from the traction element 32, but other configurations are within the scope of the invention.

The first and second tire gripping elements 26 and 30 are each provided with a substantially rough-textured inner surface 31 for frictionally engaging the tire side walls 14 and 16 with relatively large frictional forces when the traction device 10 is operatively mounted to the tire 12. For example, the inner surface 31 includes a plurality of substantially diamond-shaped protuberances that are integrally formed in the surface of first and second tire gripping elements 26 and 30. In other examples, a sheet of resilient material, such as rubber, is rigidly bonded to the surface of the first and second tire gripping elements 26 and 30 using any suitable means such as glue, a thermal-bonding process or the like. The inner surfaces 31 are substantially perpendicular to the traction element 32 and face each other.

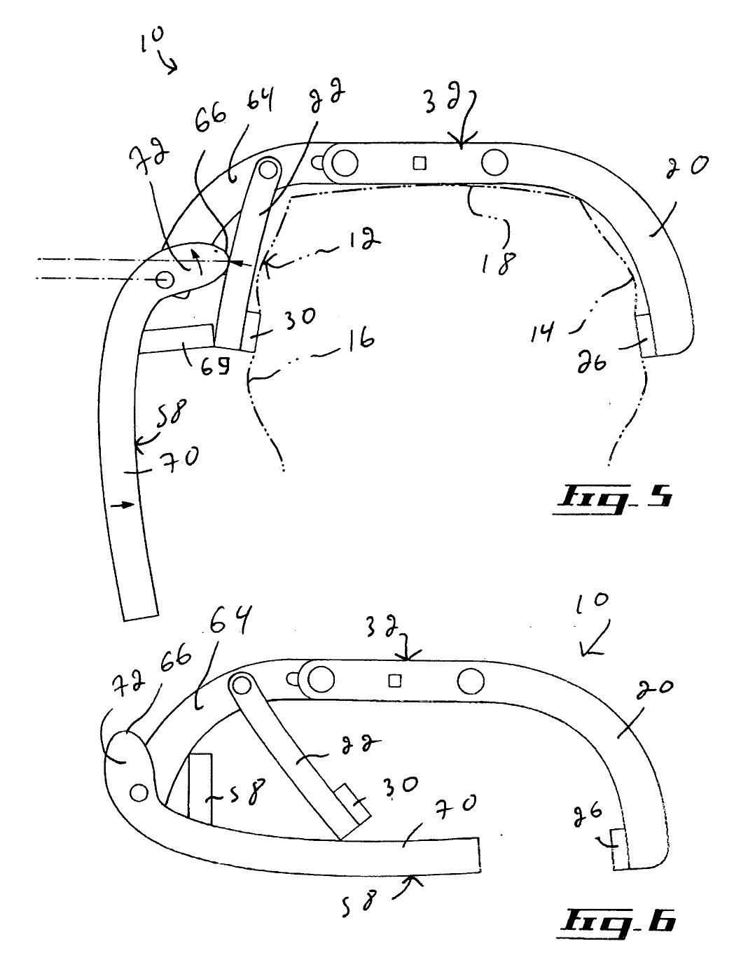

The first and second jaws 20 and 22 are operatively coupled to each other so as to be movable between an open configuration (shown for example in FIG. 3) and a closed configuration (shown for example in FIG. 5). The first and second tire gripping elements 26 and 30 are closer to each other when the first and second jaws 20 and 22 are in the closed configuration than when the first and second jaws 20 and 22 are in the open configuration.

As seen in FIG. 5, when the traction device 10 is operatively mounted to the tire 12 with the first and second jaws 20 and 22 in the closed configuration, the traction element 32 extends across the tire thread 18 and the first and second tire gripping elements 26 and 30 grip a respective one of the tire side walls 14 and 16 so as to pinch the tire 12 between the first and second tire gripping elements 26 and 30.

Typically, the traction element 32 is a variable length traction element 32 configurable between a shortest configuration and a longest configuration, the first and second jaws 20 and 22 being closer to each other in the shortest configuration than in the longest configuration. To that effect, with reference to FIG. 2, the traction element 32 includes a traction element first segment 34 extending from the first jaw 20 and a traction element second segment 36 extending from the second jaw 22. The traction element first and second segments 34 and 36 are movable relatively to each other for allowing configuration of the traction element 32 between the shortest and longest configurations.

Typically, the traction element first and second segments 34 and 36 are each substantially elongated and substantially longitudinally movable relatively to each other for allowing configuration of the traction element 32 between the shortest and longest configurations. Also, the traction device 10 typically includes a traction element lock 38 for locking the traction element 32 between the shortest and longest configurations. In some embodiments of the invention, the traction element lock 38 is able to lock the traction element 32 at any continuous length between the shortest and longest configurations, but this is not necessarily the case in alternative embodiments of the invention.

In the specific embodiment of the invention shown in the drawings, the traction element second segment 36 is provided with a substantially longitudinally extending slot 38 and the traction element first segment 34 is provided with a plurality, for example three, through holes, namely distal hole 40, intermediate hole 42 and proximal hole 44 that are rectilinearly aligned and substantially equidistantly spaced apart along the traction element first segment 34.

The holes 40, 42 and 44 are typically square-shaped for slidably receiving therethrough at least two round head bolts 46 having a square neck 48 under the head 50 and a threaded bolt shank 52, such as conventional plow bolts, to prevent the bolts 46 from turning when inserted in the holes 40, 42 and 44 with a nut element 54 tightened on their bolt shank 52. The traction element lock 38 is formed by the combination of the holes 40, 42 and 44, bolts 46 and nut elements 54.

The slot 38 has a width that is suitably sized for substantially freely slidably receiving therethrough the threaded bolt shanks 52, while having a length relatively greater than the distance separating the two most spaced apart holes 40, 42 and 44.

The actuator 56 is operatively coupled to the first and second jaws 20 and 22 for moving the first and second jaws 20 and 22 between the open and closed configurations. More specifically, the actuator 56 is operatively coupled to the second jaw 22 for pivoting the second jaw 22 relative to the traction element 32 to configure the first and second jaws 20 and 22 between the open and closed configurations.

As seen in FIG. 1, the actuator 56 includes a lever 58, which is typically substantially L-shaped and as such defines an incurvation 59. The lever 58 is operatively coupled to the second jaw 22 for pivoting the second jaw 22 relative to the traction element 32. The lever 58 defines a lever proximal end 60 and a substantially longitudinally opposed lever distal end 62. The lever proximal end 60 defines a cam surface 66 for abutting against the second jaw 22, the cam surface 66 having a substantially arcuate configuration.

A lever support 64 is mechanically coupled to the traction element 32, the lever 58 being pivotally mounted to the lever support 64. For example, the lever support 64 extends integrally and obliquely from the traction element 32, more specifically from the traction element second segment 36, substantially away from the second jaw 22. Typically, the lever 58 is pivotally mounted to the lever support 64 at a location intermediate the lever proximal and distal ends 60 and 62, the lever proximal end 60 abutting against the second jaw 22. For example, the lever 58 is pivotally mounted to the lever support 64 substantially adjacent to the incurvation 59. The lever 58 is mounted to the lever support 64 in a spaced apart relationship relative to the location at which the second jaw 22 is mounted to the traction element 32 with the second jaw 22 provided between the lever support 64 and the first jaw 20. The lever 58 is pivotally mounted to the lever support 64 in any suitable manner, for example using a rivet, or a bolt and nut combination, among other possibilities.

In some embodiments of the invention, the actuator 56 includes a stopper 69 extending from the lever 58 toward the second jaw 22 for preventing a rotation of the lever 58 toward the second jaw 22 beyond a predetermined angle. The stopper 69 abuts against the second jaw 22, along with the cam surface 66, when the predetermined angle has been reached, thereby preventing further rotation of the lever 58.

Typically, the traction element first segment 34 and the first jaw 20 together are substantially L-shaped and the first jaw 20 is substantially arcuate, which helps in providing grip to the traction device in soft material while transmitting effectively forces between the traction element 32 and the first jaw 20. Similarly, the traction element second segment 36 and the lever support 64 together are substantially L-shaped and the lever support 64 is substantially arcuate, with similar benefits.

As an example, a specific manner of manufacturing the proposed traction device 10 is hereby described. The first jaw 20 and traction element first segment 34 are formed integrally of a flat metal piece. The second jaw 22 may be made from flat bar stock that has been appropriately bent in an elongated U-shaped configuration (as best illustrated in FIG. 1), thus leaving an elongated open slot 68 substantially extending the full length of the second jaw 22. The open slot 68 thus created allows an extended pivotable movement of the second jaw 22 about the traction element second segment 36, particularly inwardly, which allows the traction device 10 to be folded in a compact, stowable configuration (as shown in FIG. 5).

Lever 58 is embodied in a substantially L-shaped, elongated member generally defined by an elongated, rectilinear handle portion 70, a relatively shorter locking cam portion 72 extending at a substantially right angle relative to the handle portion 70, and a spacer jaw portion 74 extending adjacently, and in a parallel fashion, relative to the general orientation of the locking cam portion 72. Furthermore, the lever 58 is provided with a pivot support at roughly the junction between the elongated handle portion 70 and the locking cam portion 72, for pivotably coupling the lever 58 to the lever support 64.

The locking cam portion 72 has a substantially rounded-shaped distal end that defines the cam surface 66 and whose role is to press, and lock in a pressed state, on a rear portion of the second jaw 22, which, in turn, is forced into an inwardly pendulum movement toward the oppositely disposed tire gripping element 26.

The locking aspect of the lever 58 is best explained through FIGS. 3, 4 and 5, which illustrate sequentially a mode of installation of the traction device 10. FIG. 3 shows the traction device 10 in a proper initial position, in the open configuration, ready to be clamped about the tire side walls 14 and 16 of the tire 12. As illustrated, the traction device 10 is positioned by the user in a straddling relation about the tire thread 18 and side walls 14 and 16 of the conventional rubber tire 12, with the lever 58 pivoted outwardly and generally oriented towards the user, and the oppositely disposed tire gripping elements 26 and 30 snugly abutting on a respective one of the tire side walls 14 and 16.

As the lever 58 is pivoted inwardly towards the center of the wheel, such as illustrated in FIG. 4, the locking cam portion 72 progressively applies pressure on the second jaw 22, which, in turn, forces the opposite tire side walls 14 and 16 to be resiliently squeezed between the pair of tire gripping elements 26 and 30.

As the lever 58 is pivoted, the cam surface 66 first reaches the peak pressure point applied on the second jaw 22, when the deflection of the second jaw 22 is maximal, and then passes on to reach its locking position in which the location at which the cam surface 66 contacts the second jaw 22 is between the pivot locations of the second jaw 22 and lever 58, which retracts slightly the second jaw 22 as compared to its maximal deflection. At this point, the stopper 69 abuts against the second jaw 22.

It is to be noted that, once the traction device 10 is properly clamped about a peripheral portion of the tire 12, the stopper 69 is of a suitably length relative to the locking cam portion 72 to leave the elongated handle portion 70 at an appreciable distance from the hub portion of the wheel (not shown). Thus, the manipulation of the pivotable lever 58 by a user during the application and removal process of the traction device 10 is made safe and easy, and, as well, avoids any damaging contact that may occur between the handle portion 70 and the aesthetical surface of a wheel cover or wheel of the vehicle.

The removal process of the traction device 10 from a clamped state about tire 12 essentially consists of pivoting the handle portion 70 outwardly and removing the thus released traction device 10 from the tire.

Prior to installing the tire traction device 10 in an initial position, as shown in FIG. 3, it may be required to adjust the device to the width of the tire 12 by, first, untightening the pair of bolts and nuts combinations 46 and 54. Secondly, by slidably adjusting the relative position of the traction element first and second segments 34 and 36 such that the traction device 10 may have its first and second tire gripping elements 26 and 30 snugly abutting each against a respective tire side wall 14 and 16, as shown in FIG. 3, and then retightening the bolts and nuts combinations 46 and 54. It is to be noted that the traction device 10 may be adjusted to the width of rubber tires that are relatively wider than standard tires by simply transposing the bolt and nut combination 46 and 54 to the intermediate hole 42, which allows a greater slidable adjustment of the relative position between the traction element first and second segments 34 and 36.

In a similar manner as with the second jaw 22 described above, the lever 58 may be made from flat bar stock that has been appropriately bent in an elongated U-shaped configuration and whose pair of free distal ends form the cam surface 66 and straddle the second jaw 22 in a co-planar fashion. Thus, the lever 58, cooperatively with the second jaw 22, may be folded inwardly such that the traction device 10 may have a compact, stowable configuration, as shown in FIG. 6.

As already addressed above, the traction device 10 may be advantageously made from conventional flat bar stock that has been preferably subjected to a rust-proof treatment, or may be made from any suitable rust-proof metals such as, for example, aluminum or stainless steel.

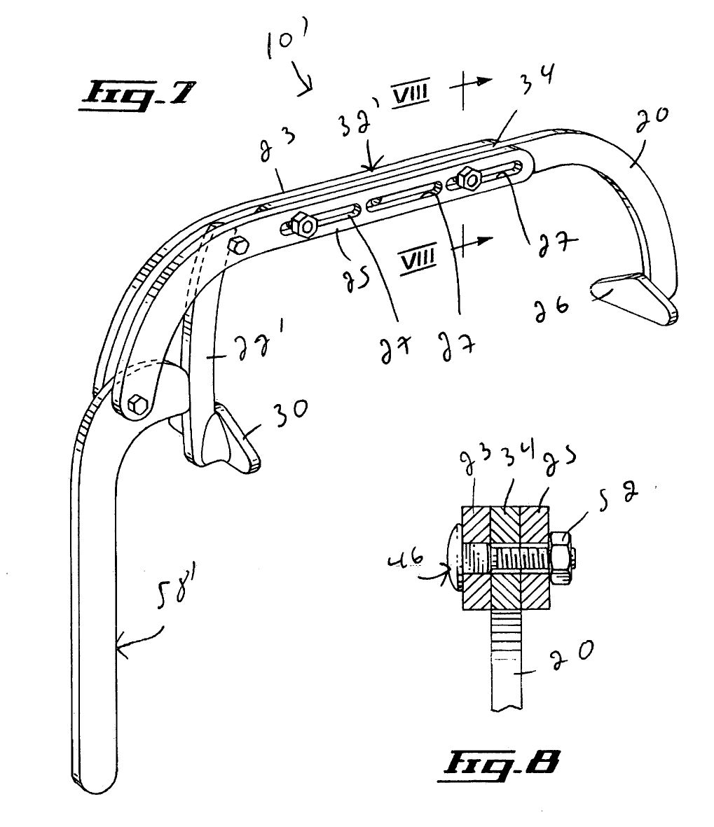

FIGS. 7 and 8 illustrate an alternative traction device 10′ in which the traction element second segment 36′ of an alternative traction element 32′ includes a pair of substantially parallel traction element second segment elements 23 and 25 disposed in a substantially parallel and spaced apart relationship relative to each other. Each of the traction element second segment elements 23 and 25 is provided with a number of substantially longitudinally extending slits 27 that corresponds to the number of holes 40, 42 and 44 (all not shown in FIG. 7) provided in the traction element first segment 34. The shape of the traction element second segment elements 23 and 25 is substantially similar to the shape of the traction element second segment 36. In these embodiments, the second jaw 22′ and the lever 58′ are each substantially flat and pivotally mounted between the traction element second segment elements 23 and 25. Otherwise, the traction device 10′ operates substantially similarly to the traction device 10 and will therefore not be described in further details herein.

Although the present invention has been described hereinabove by way of preferred embodiments thereof, it can be modified, without departing from the spirit and nature of the subject invention as defined in the appended claims.

What is claimed is:

1. A traction device attachable to a tire, said tire defining a pair of substantially annular and substantially opposed tire side walls, said tire also defining a tire thread extending between said tire side side walls, said traction device comprising:
a first jaw, said first jaw defining a first jaw free end, said first jaw including a first tire gripping element provided substantially adjacent to said first jaw free end;
a second jaw, said second jaw defining a second jaw free end, said second jaw including a second tire gripping element provided substantially adjacent to said second jaw free end;
said first and second jaws being operatively coupled to each other so as to be movable between an open configuration and a closed configuration, said first and second tire gripping elements being closer to each other when said first and second jaws are in said closed configuration than when said first and second jaws are in said open configuration;
said traction device further comprising a traction element extending between said first and second jaws substantially opposed to said first and second jaw free ends;
wherein, when said traction device is operatively mounted to said tire with said first and second jaws in said closed configuration, said traction element extends across said tire thread and said first and second tire gripping elements grip a respective one of said tire side walls so as to pinch said tire between said first and second tire gripping elements.

2. A traction device as defined in claim 1, wherein said traction element is a variable length traction element configurable between a shortest configuration and a longest configuration, said first and second jaws being closer to each other in said shortest configuration than in said longest configuration.

3. A traction device as defined in claim 2, wherein said traction element includes a traction element first segment extending from said first jaw and a traction element second segment extending from said second jaw, said traction element first and second segments being movable relatively to each other for allowing configuration of said traction element between said shortest and longest configurations.

4. A traction device as defined in claim 3, wherein said traction element first and second segments are each substantially elongated, said traction element first and second segments being substantially longitudinally movable relatively to each other for allowing configuration of said traction element between said shortest and longest configurations.

5. A traction device as defined in claim 2, further comprising a traction element lock for locking said traction element between said shortest and longest configurations.

6. A traction device as defined in claim 1, further comprising an actuator operatively coupled to said first and second jaws for moving said first and second jaws between said open and closed configurations.

7. A traction device as defined in claim 6, wherein said first jaw is substantially fixed relative to said traction element and said second jaw is pivotable relative to said traction element, said actuator being operatively coupled to said second jaw for pivoting said second jaw relative to said traction element to configure said first and second jaws between said open and closed configurations.

8. A traction device as defined in claim 7, wherein said actuator includes a lever operatively coupled to said second jaw for pivoting said second jaw relative to said traction element.

9. A traction device as defined in claim 8, further comprising a lever support mechanically coupled to said traction element, said lever being pivotally mounted to said lever support.

10. A traction device as defined in claim 9, wherein said lever defines a lever proximal end and a substantially longitudinally opposed lever distal end, said lever being pivotally mounted to said lever support at a location intermediate said lever proximal and distal ends, said lever proximal end abutting against said second jaw.

11. A traction device as defines in claim 10, wherein said lever is substantially L-shaped.

12. A traction device as defined in claim 10, wherein said lever defines an incurvation, said lever being pivotally mounted to said lever support substantially adjacent to said incurvation.

13. A traction device as defined in claim 10, wherein said actuator includes a stopper extending from said lever toward said second jaw for preventing a rotation of said lever toward said second jaw beyond a predetermined angle.

14. A traction device as defined in claim 9, wherein said lever support extends obliquely relative to said traction element in a direction leading substantially away from said second jaw.

15. A traction device as defined in claim 9, wherein said lever defines a cam surface abutting against said second jaw, said cam surface having a substantially arcuate configuration.

16. A tire and traction device combination, said combination comprising:
a tire, said tire defining a pair of substantially annular and substantially opposed tire side walls, said tire also defining a tire thread extending between said tire side side walls;
a traction device, said traction device including:
a first jaw, said first jaw defining a first jaw free end, said first jaw including a first tire gripping element provided substantially adjacent to said first jaw free end;
a second jaw, said second jaw defining a second jaw free end, said second jaw including a second tire gripping element provided substantially adjacent to said second jaw free end;
said first and second jaws being operatively coupled to each other so as to be movable between an open configuration and a closed configuration, said first and second tire gripping elements being closer to each other when said first and second jaws are in said closed configuration than when said first and second jaws are in said open configuration;
said traction device further comprising a traction element extending between said first and second jaws substantially opposed to said first and second jaw free ends;
said traction element extending across said tire thread and said first and second tire gripping elements gripping a respective one of said tire side walls so as to pinch said tire between said first and second tire gripping elements.
